(19) United States
(12) Patent Application Publication
(10) Pub. No.: US 2021/0146635 A1
(43) Pub. Date: May 20, 2021

(54) SECURING A SECOND OBJECT TO A FIRST OBJECT

(71) Applicant: Woodwelding AG, Stansstad (CH)

(72) Inventors: Jörg Mayer, Niederlenz (CH); Marcel Aeschlimann, Ligerz (CH); Laurent Torriani, Lamboing (CH); Slobodan Glavaski, Biel (CH); Joakim Kvist, Nidau (CH)

(21) Appl. No.: 16/650,483

(22) PCT Filed: Sep. 24, 2018
(86) PCT No.: PCT/EP2018/075827

§ 371 Date: Mar. 25, 2020

(30) Foreign Application Priority Data
Sep. 27, 2017 (CH) 01184/17

(51) Int. Cl. B29C 65/06; B29C 65/60; B29C 65/00; F16B 5/08

(52) U.S. Cl. CPC B29C 65/0636; B29C 65/069; B29C 65/603; B29C 66/02242; B29L 2031/30; B29C 66/7392; B29C 66/8322; F16B 5/08; B29C 66/474

(57) ABSTRACT

A method of anchoring a connector in a first object is provided, wherein the connector includes thermoplastic material in a solid state. The method includes bringing the connector into physical contact with the first object, rotating the connector relative to the first object around a proximodistal rotation axis and exerting a relative force by the connector onto the first object, until a flow portion of the thermoplastic material of the connector becomes flowable and flows relative to the first object, and stopping rotation of the connector, whereby the flow portion anchors the connector relative to the first object, wherein a distal end of the connector is equipped for cutting/punching into the first object and/or for removing material therefrom.

### BACKGROUND OF THE INVENTION

### Field of the Invention

The invention is in the fields of mechanical engineering and construction, especially mechanical construction, for example automotive engineering, aircraft construction, shipbuilding, machine construction, furniture manufacturing, toy construction, etc. In particular, it relates to a method of mechanically anchoring a connector in a first object.

### Description of Related Art

In the automotive, aviation and other industries, there has been a tendency to move away from steel-only constructions and to use lightweight material instead. Similarly, in the furniture industry, solid wood and engineered wood are increasingly replaced by lightweight elements.

An example of new building material elements are lightweight building elements that include two outer, comparably thin building layers, for example of a fiber composite, such as a glass fiber composite or carbon fiber composite, a sheet metal or also, depending on the industry, of a fiberboard, and a middle layer (interlining) arranged between the building layers, for example a honeycomb structure of cardboard or other material, or a lightweight metallic foam or a polymer foam or ceramic foam, etc., or a structure of discrete distance holders. Lightweight building elements of this kind may be referred to as “sandwich boards” and are sometimes called “hollow core boards (HCB)”. They are mechanically stable, may look pleasant and have a comparably low weight.

A further category of new materials are compressible foams such as Expanded Polysterene (EPS) or Expanded Polypropylene (EPP). Such materials may be present as interlining layers of lightweight building elements of the above-described kind and/or may be covered by a hard building layer, or may be present without such hard building layer.

An even further category of new materials are pressed non-woven fabrics.

The new materials cause new challenges in bonding objects to elements of these materials.

Further, according to the state of the art, reinforcements in sandwich board constructions have to be provided during their manufacture, and also connecting elements have to be added during manufacturing. If they are subsequently added, the sandwich core has to be foam-filled subsequently to fastening the connector, which is costly and time consuming.

To meet these challenges and eliminate possible disadvantages, the automotive, aviation and other industries have started heavily using adhesive bonds. Adhesive bonds can be light and strong but suffer from the disadvantage that there is no possibility to long-term control the reliability. A degrading adhesive bond, for example due to an embrittling adhesive, is almost impossible to detect without entirely releasing the bond. Also, adhesive bonds may lead to a rise in manufacturing cost, both, because of material cost and because of delays caused in manufacturing processes due to slow hardening processes, especially if the surfaces to be connected to each other have certain roughness and as a consequence the quickly hardening thin-layer adhesives cannot be used. Further, because it is effective only at the surface, an adhesive bond cannot be stronger than a material strength at the surface. In a sandwich board, this is the material strength of one of the building layers, or of an outermost sub-layer thereof.

WO 2008/080238 teaches approaches of anchoring a joining element in an object, for example in a hollow core board, by mechanical vibration.

WO 2015/162029 discloses a method for connecting two components, one of which consists of a fiber-reinforced composite material, to each other. WO 2015/135824 discloses a device for setting a setting element in a component, for example in a component including a honeycomb structure of plastic or a paper-like material and a cover layer of a metal material. Both of these approaches include anchoring the connecting element/setting element by rotating it relative to the respective component in which it is anchored.

There is still room for improvement of prior art connecting methods.

### SUMMARY OF THE INVENTION

It is therefore an object of the present invention to provide a method of mechanically securing a connector to a first object, the method overcoming disadvantages of prior art methods. Especially, it is an object of the present invention to provide a method of mechanically securing a connector to a lightweight building element, which method has the potential of being low-cost, efficient and quick.

According to an aspect of the invention, a method of anchoring a connector in a first object is provided, wherein the connector includes thermoplastic material in a solid state. The method includes the steps of:
bringing the connector into physical contact with the first object,
rotating the connector relative to the first object around a proximodistal rotation axis and exerting a relative force by the connector onto the first object, until a flow portion of the thermoplastic material of the connector becomes flowable and flows relative to the first object, and
stopping rotation of the connector, whereby the flow portion anchors the connector relative to the first object,
   wherein at least one of the following conditions is fulfilled:
A. the connector is shaped so that a distal-most end thereof is different from a contact point on the proximodistal rotation axis;
B. the connector has a macroscopic surface roughness at a location that during rotation is pressed against the first object;
C. the connector includes a portion of a second material different from the thermoplastic material, wherein the second material is solid and does not become flowable (during the process), and wherein the portion either extends to the distal end or extends through a middle plane perpendicular to the axis, or both;
D. during the step of rotating, the connector is subject to an orbital movement;
E. the connector has an inner portion and a proximal connecting portion with a distally facing connecting protrusion, wherein during the step of rotating, the connecting protrusion is pressed against a proximally facing end face of the first object and a surface part of the inner portion is pressed against a first object structure underneath (distally of) the proximally facing end face;
F. the first object includes a structure of fibers or a foam material, and the flow portion is caused to flow into the structure of fibers or into pores of the foam material, respectively.

The named conditions A-F can be realized individually. Alternatively, all combinations of the named conditions are possible, i.e. AB, ABC, ABCD, ABCDE, ABCDF, ABCDEF, ABD, ABDE, ABDF, ABDEF, ABE, ABF, ABEF, AC, ACD, ACDE, ACDF, ACDEF, ACE, ACF, ACEF, AD, ADE, ADF, ADEF, AE, AF, AEF, BC, BCD, BCDE, BCDF, BCDEF, BCE, BCF, BCEF, BD, BDE, BDF, BDEF, BE, BF, BEF, CD, CDE, CDF, CDEF, CE, CF, CEF, DE, DF, DEF, EF.

The relative force may be a pressing force.

The step of exerting the relative force may especially cause the connector or at least a distal portion thereof to advance into the first object.

Referring to condition A., the distal-most end may, for example, form one of:
a circular contact line, for example formed by a distal edge formed by a circular ridge;
a saw-tooth structure;
an edge running different from circumferentially,
an abrasive area, for example a circular or ring-shaped area;
a hollow, sleeve-like distal end, with the sleeve-like portion (tube portion) extending distally from a body. Such body in embodiments may form a head portion;
a cutting/punching structure from a second material in the sense of condition C.

Especially, in embodiments (referring to any condition), the first object may be a lightweight building element having a first building layer, an interlining layer, and for example also a second building layer, wherein the first and, if applicable, second building layer(s) is/are thinner and more dense (and generally also harder as far as the—average—hardness of the interlining layer is defined) than the interlining layer, if applicable the first and second building layers sandwiching the interlining layer. (As a remark, if this is combined with condition F. This means that the interlining may include a structure of fibers and/or a foam material.) If at least condition A. is fulfilled, in embodiments the method may include punching out a portion of the first building layer. To this end, the connector includes a distal punching structure, for example according to one of the above options, for example by a sleeve-like distal end, or an other, for example, a circumferential punching edge.

Such punching step, may be carried out prior to the onset of the rotational movement, during the onset, or thereafter. In the latter cases, the process parameters are controlled in a manner that the mechanical resistance of the distal end of the connector remains sufficiently strong (and is not fully liquefied) until the portion of the first building layer has been punched out. For example, the rotation velocity may be reduced until the punching step has been completed.

It is possible that the punching step is assisted by vibration of the connector in addition or as an alternative to being assisted by the rotational movement.

In any embodiment of any aspect of the invention, the connector may have a distal section and a proximal section. The distal section is that section/portion of the connector that after the step of stopping the rotation protrudes into the first object, whereas the proximal section does not penetrate into the first object, i.e., is proximally of a surface plane defined by the first object in a region around the attachment location (the location where the connector is anchored in the first object). For example, in embodiments in which the connector includes a head portion with a distally facing stop face (see below), the head portion forms the proximal section, and the portion that is distally of the stop face forms the distal section.

In embodiments that fulfil condition A or more generally in any embodiment of the invention, the distal section may define a distal section surface that has a shape that is different from rotationally symmetrical around the rotation axis.

The condition that the distal section defines a distal section surface that has a shape that is different from rotationally symmetrical around the rotation axis may be fulfilled independent of conditions A-F, i.e., it may be combined with any one of conditions A-F or any combination as listed hereinbefore, or also possibly without any one of conditions A-F being fulfilled. Such asymmetry in combination with the rotation (for example, this asymmetry is always fulfilled in case the connector has a saw-tooth structure or has edge running different from circumferentially) will contribute to the cutting/punching or especially material removing effect of the connector on the first object.

Referring to condition B, a macroscopic surface roughness is a roughness that is larger than a residual (microscopic) roughness that comes about when an element is manufactured, for example, by injection moulding. For example, the roughness (Ra, arithmetic average roughness) of such roughened portion may be at least 10 μm or at least 20 μm or even at least 50 μm.

The roughness can be restricted to a part of the connector surface, especially a portion at an essentially distally facing end face (this includes the possibility that the roughened portion is a portion of a radially outer surface portion of a tapering section) or other outer surface portion that during the process is pressed against structures, or it can concern the entire connector surface or the entire surface of that part of the connector that at the end of the process goes into the first object.

Referring to condition C, the second material herein especially is a non-liquefiable material, wherein “non-liquefiable” means “not liquefiable under the conditions that apply during the process”. In this text, therefore, generally a “non-liquefiable” material is a material that does not liquefy at temperatures reached during the process, thus especially at temperatures at which the thermoplastic material of the connector is liquefied. This does not exclude the possibility that the non-liquefiable material would be capable of liquefying at temperatures that are not reached during the process, generally far (for example, by at least 80° C.) above a liquefaction temperature of the thermoplastic material or thermoplastic materials liquefied during the process. The liquefaction temperature is the melting temperature for crystalline polymers. For amorphous thermoplastics the liquefaction temperature (also called “melting temperature in this text”) is a temperature above the glass transition temperature at which the becomes sufficiently flowable, sometimes referred to as the ‘flow temperature’ (sometimes defined as the lowest temperature at which extrusion is possible), for example the temperature at which the viscosity drops to below 10⁴ Pa*s (in embodiments, especially with polymers substantially without fiber reinforcement, to below 10³ Pa*s)), of the thermoplastic material.

For example, a non-liquefiable material may be a metal, such as aluminum or steel, a ceramic material, or wood, or a hard plastic, for example a reinforced or not reinforced thermosetting polymer or a reinforced or not reinforced thermoplastic with a melting temperature (and/or glass transition temperature) considerably higher than the melting temperature/glass transition temperature of the liquefiable part, for example with a melting temperature and/or glass transition temperature higher by at least 50° C. or 80° C. or 100° C. In a special example, the second (non-liquefiable) material may be a filled polymer with the matrix material being the same as the thermoplastic material but with a filler content (for example fiber content) substantially higher, for example by at least 10-15% (vol.) than the thermoplastic material.

In a group of embodiments, the non-liquefiable material forms a distal cutting/punching and/or material removal feature, such as a distal cutting edge. Especially in these embodiments, the method may include causing the body of the non-liquefiable material to retract relative to the thermoplastic material during the step of exerting the relative force so that after some time the distal end of the connector is formed by thermoplastic material.

Referring to condition D, the orbital movement may include a rotation of the rotation axis around a parallel orbit axis, wherein the rotation around the orbit axis is much slower than the rotation around the rotation axis, especially slower by at least one order of magnitude.

The invention according to this aspect is based on the insight that especially for comparably hard surfaces of the object into which the connector is to be pressed during the process, it may be advantageous if the connector has the potential of having a double function: during an initial stage, functions for separating (cutting/punching into) portions of the first object and/or removing material from the first object, for example for the connector to be pushed through a surface of the first object and/or for a bore in the first object to be made or enlarged. Then, during a further stage, the flow portion of the thermoplastic material of the connector becomes flowable and serves for anchoring the connector.

These first and/or second stages may be distinctly one after the other, or they may overlap.

Referring to condition E, the approach according to this condition brings about the new approach that thermoplastic material may be liquefied, for interpenetration of structures and later re-solidification for anchoring, both, at a proximal end face and at an other location deeper in the object. Especially if the object is a lightweight building element with a first, proximal building layer, the connecting portion with the connecting protrusion anchors the connector in the—usually dimensionally stable—first building layer from proximally, so that the first building layer's dimensional stability is used.

Also, the connecting portion may extend radially outwardly from the inner portion. Thereby, the connecting portion in addition to anchoring from proximally in the proximally facing surface enhances the footprint of the anchoring.

Further, if the first object is a lightweight building element having both, a first and a second building layer, the approach according condition E may enable the connector to be anchored both, in the first building layer, from proximally, by the connecting portion and in the second building layer or adjacent the second building layer by a distal part of the inner portion.

Again referring to condition E, the inner portion may, for example, have a tube-shaped distal end and fulfil condition A, for example by being entirely tube-shaped or by having a proximal massive part and a distal tube-shape part. Independent of this, the connecting portion may form a proximal flange around the inner portion. The connecting portion may have the distally facing connecting protrusion as a circumferential ridge extending distally from such flange. Such flange may also have the function of a head portion enhancing the stability and/or for example useable for securing a further object to the first object, similarly to a nail.

The conditions A-E all have the effect of enhancing the connectors capability of working into material of the first object.

In a group of embodiments, the first object is a lightweight building element having a first outer building layer (also called first building layer in this text) and an interlining layer, wherein the first outer building layer is thinner and more dense (and generally also harder as far as the—average—hardness of the interlining layer is defined) than the interlining layer. The first object may further have a second building layer, for example of a same material as the first building layer, and the first and second building layers sandwiching the interlining layer.

The interlining layer may, for example include a macroscopic, dedicated structure with a large portion of hollow spaces, whereby the density of the interlining layer is comparably small. For example, the interlining layer may include vertically extending walls (walls extending parallel to the axis) between the first and second outer building layers. In embodiments, such walls form a honeycomb structure.

In this group of embodiments, bringing the connector into contact with the first object may include bringing the connector into contact with the first building layer.

In this group of embodiments, the first building layer may be provided with a pre-formed bore (pilot hole) prior to the step of bringing the connector into contact with the first building layer. Alternatively, especially the first building layer may be intact prior to the step of bringing the connector into contact with it, whereby the distal-most end of the connector contacts the first building layer and cuts/punches into it and/or removes material from it.

As an alternative to being a lightweight building element in the above-mentioned sense, the first object may be any other object of construction/engineering. For example, the first object may include a structure of fibers, for example constituting the proximally facing surface of the first object. Such structure of fibers in embodiments may form a covering layer covering a harder structure underneath.

In embodiments, especially but not only if condition A and/or condition B and/or condition E is met, the connector may have a region with a cross section that continually increases towards proximally (such as a taper), which region during rotation is pressed into the first object. Optionally, such region may have a structure of ribs and grooves, with a homogeneous enveloping rotation surface.

According to a further option, again especially but not only if condition A and/or condition B and/or condition E is met, the connector may have a weakening feature (collapse zone; for example by a circumferential inner and/or outer groove), and the step of rotating is carried out until the connector collapses at the location of the weakening feature for enhancing a flow of the flow portion towards radially outwardly.

Now referring to condition F, a first category of materials are non-woven fibers, such as pressed non-woven fibers. This material gains increasing popularity in lightweight construction, due to its properties that include excellent damping and low cost. However, anchoring with respect to this kind of material is a challenge. It has been found that the approaches described in the present text are suitable for anchoring in this material.

A connector used if condition F is fulfilled may, depending on the geometry of the first object, be comparably flat, i.e., its radial extension (width) may be larger than an axial extension of an anchoring portion that includes liquefiable material and is pressed into the first object for anchoring. Especially, the connector may have a disc-shaped portion with the anchoring portion formed by at least one circumferential ridge.

In embodiments, especially if the connector has a disc-shaped portion, the anchoring process may be carried out until a distal surface thereof is pressed against material of the first object and slightly compresses it. The distal surface thereby serves as natural stop face.

In embodiments, prior to the onset of the rotations, the connector may be pressed by an axial movement into the material of the first object. Thereby, locally, at the location of the anchoring portion(s), the fiber structure is compressed to yield a compressed portion. This may assist the anchoring process in that the friction between the material of the first object and the thermoplastic material of the anchoring portion(s) is enhanced yielding an enhanced energy absorption, while also the resistance against the fibers merely being pulled along in the rotational movement is also enhanced.

In embodiments with the connector anchoring portion being pressed into the object prior to the onset of the rotation, this may even be done to an extent that a also distal end face of the connector is pressed against material of the first object and slightly compresses it. Then, the distally protruding anchoring portion is fully immersed in material of the first object when the rotation sets in.

The anchoring by the approach fulfilling condition F may be different from a mere superficial connection in that the anchoring portion(s) anchor the connector in a depth-effective manner. This means that the anchoring portions stay in position in the anchoring process and are present, extending into material of the first object, also after termination of the anchoring process—although of course with a changed shape due to the liquefaction and re-solidification.

A further group of materials for which approaches described in this text are attractive are foam materials, especially expanded polymer foams. The method may be used both, with foam materials that remain solid under the conditions that apply during the process but with structures interpenetrated by the thermoplastic material, and with foam materials that liquefy and for example are welded to thermoplastic material of the connector or at least be mixed with it. Due to the approach according to the different aspects of the present invention, in contrast to the prior art in addition to a weld or adhesive bond, also a positive-fit connection is generated by the thermoplastic material of the connector interpenetrating structures of the first object.

The anchoring of the connector relative to the first object caused by the connector may be due to one or more of:
The flow portion interpenetrating structures of the first object, for example of an interlining thereof, of spaces between fibers and/or of pores if the first object includes a foam, wherein after re-solidification of the flow portion a positive-fit connection results;
A weld between material of the first object and of the connector. In this case, the absorption of the mechanical rotation energy (due to friction) will also cause some portion of material of the first object to be flowable.

To this end, especially, the first object may have a region in in which the flow portion is anchored, which region does not consist of liquefiable material but includes non-liquefiable, penetrable material. A penetrable material suitable for this is solid at least under the conditions of the method according to the invention. For example, this material may be rigid, substantially not elastically flexible (no elastomer characteristics) and not plastically deformable and it may be not or only very little elastically compressible. It further includes actual or potential spaces into which the liquefied material can flow or be pressed for the anchoring. It is, e.g., fibrous or porous or includes penetrable surface structures, which are, e.g., manufactured by suitable machining or by coating (actual spaces for penetration). Alternatively the penetrable material is capable of developing such spaces under the hydrostatic pressure of the liquefied thermoplastic material, which means that it may not be penetrable or only to a very small degree when under ambient conditions. This property (having potential spaces for penetration) implies, e.g., inhomogeneity in terms of mechanical resistance. An example of a material that has this property is a porous material whose pores are filled with a material that can be forced out of the pores, a composite of a soft material and a hard material or a heterogeneous material (such as wood) in which the interfacial adhesion between the constituents is smaller than the force exerted by the penetrating liquefied material. Thus, in general, the penetrable material includes an inhomogeneity in terms of structure (“empty” spaces such as pores, cavities, etc.) or in terms of material composition (displaceable material or separable materials).

It is not excluded that a region of penetrable material also includes thermoplastic liquefiable material, for example capable of making a weld with the material of the connector—for example as a coating of non-liquefiable material, or as part of an other inhomogeneous mixture.

In addition to a method, the present invention also concerns a connector for carrying out the method. Such connector may have an axis (corresponding to the rotation axis in the embodiments of the method described herein before) and including thermoplastic material. It further has an engagement structure, for example engagement opening, for a tool to engage. Such engagement structure is different from rotationally symmetrical about the axis.

Especially be configured as described in this text referring to the method. This may especially imply that it fulfils one or more of conditions A, B, C or E, possibly with the properties described in this text referring to the method.

According to an other aspect of the invention, a method of anchoring a connector in a first object is provided, wherein the first object is a lightweight building element having a first building layer, an interlining layer, and a second building layer, wherein the first and second building layers are thinner and more dense (and generally also harder as far as the—average—hardness of the interlining layer is defined) than the interlining layer, the first and second building layers sandwiching the interlining layer. The connector includes thermoplastic material in a solid state. The method includes the steps of:
bringing the connector into physical contact with the first object,
rotating the connector relative to the first object around a proximodistal rotation axis and exerting a relative force by the connector onto the first object, until a flow portion of the thermoplastic material of the connector becomes flowable and flows relative to the first object, and
stopping rotation of the connector, whereby the flow portion anchors the connector relative to the first object,
wherein the process includes monitoring the relative force and wherein the step of stopping the rotation of the connector is carried out when a pre-defined condition relating to the pressing force is met, for example when the pressing force exceeds a threshold value.

In addition or as an alternative, the process may include using a distance control, i.e., the rotation is stopped as soon as the connector has reached a pre-defined position so that it can be excluded that the connector also pierces the second building layer.

In all embodiments of the different aspects of the present invention that include using a lightweight building element with a first building layer and an interlining layer as the first object, the method may include:
by the action of the rotation and/or the relative force, displacing a portion of the first building layer with respect to the interlining layer and/or causing the first outer building layer to be pierced as a result of the application of the relative force at the location (attachment location) where the connector is in physical contact with the first object or in a vicinity thereof;

Especially, if the first building layer defines a plane around an attachment location, the method may include displacing the first building layer with respect to the plane at the attachment location towards a distal direction.

In the step of displacing, a displaced portion of the first outer building layer may be separated from the first outer building layer, i.e., the first outer building layer in the process is disrupted as opposed to being merely deformed. In embodiments, the displaced portion may, however, remain contiguous, i.e., be separated from the first building layer and displaced as a whole. This does not exclude the possibility that the displaced portion is also deformed in addition to being separated from the first outer building layer and to being displaced.

Especially, the step of displacing may include punching out or breaking out the displaced portion from the first outer building layer.

The step of displacing may include displacing the portion towards a distal direction, thereby causing material of the interlining distally of the portion to be compressed. It has been found, that such compression of the interlining may lead to additional anchoring stability

In a special group of embodiments, the connector is provided with a collapse zone allowing a part distally of the collapse zone to be deformed relative to the rest of the connector (first type collapse zone, zone for distal collapse). Especially, such portion may be caused to be bent outwardly from the collapse zone on, so that the connector gets a larger footprint. Such collapse zone may be formed by a zone of reduced cross section, for example in according embodiments by a zone of reduced sleeve thickness running around the sleeve-like portion.

In embodiments, the connector includes a head portion or other laterally protruding proximal feature. Such laterally protruding feature may serve as stopping feature, i.e. the energy input may be stopped as soon as a distally facing shoulder of the head portion (or other laterally protruding proximal feature) comes into physical contact with the first building layer or with the proximal surface of a second object to be bonded to the first object by the connector.

In embodiments, the first building layer may have some porosity and/or have a constituent capable of being welded to material of the connector. In such embodiments, a distally facing end face of the head portion (or other laterally protruding proximal feature) may be of (the) thermoplastic material and may be caused to be made flowable at least partially during the last stage of the step of rotating whereby the material of the head portion (or other laterally protruding proximal feature) is caused to infiltrate material of the first building layer (and/or to weld to it). Optionally, to this end the head portion may have a small distal concave feature to confine the melt that arises during the process.

A porosity and/or capability to weld of the first building layer may also contribute to anchoring if the connector does not have a head portion (or similar) but is, for example, slightly tapering whereby material of the connector is made flowable in contact with the mouth of the opening through which the connector extends, and such flowable material may interpenetrate the first building layer and/or weld to it, respectively.

A second object to be bonded to the first object may include a portion with an opening, optionally a generally flat sheet portion with such opening. Such sheet portion may lie directly against the proximal surface of the first building layer and be in physical contact with it. Alternatively, a further part, such as a thin sheet or membrane, may be placed between the first object and the sheet portion. The opening, through which the connector extends after the process, may be a through opening or may be a recess that is open to a lateral side (such as a slit or similar).

In embodiments, bonding such second object to the first object may include at least one of the following measures:
The second object around the opening has a section projecting away from a plane of the first building layer towards proximally, and a portion of the connector—for example, a peripheral laterally protruding feature (collar/head or similar)—towards the end of the anchoring process comes into contact with the edge, whereby energy coupled into the connector causes a portion of the thermoplastic material to be made flowable due to friction heat generated between the edge and the thermoplastic material, and the flowable material flows around the edge to at least partially embed the edge in the thermoplastic material. Thereby, an additional connection and, depending on the geometry of the edge and of the connector, also a sealing is achieved.
The second object has thermoplastic material where in contact with the first building layer, and at least a portion of this thermoplastic material is caused to flow relative to the first building layer, whereby a structure of the surface of the first building layer is interpenetrated and/or a weld is formed with material of the first building layer, so that an additional connection and possibly also a sealing is achieved.
Between the laterally protruding feature of the connector and the proximal surface of the second object and/or between the second object and the first building layer, and adhesive is placed. Such adhesive may be a curable adhesive. Due to the effect of mechanical energy, the viscosity may initially become reduced so that the adhesive may flow into structures of the first object, the second object and/or the connector. In addition or as an alternative, the mechanical energy may accelerate the curing process. In addition or as an alternative to a curable adhesive, also a thermoplastic adhesive (hot melt adhesive) may be used.
Flowable and re-solidified material of the connector causes a positive-fit connection with the second object, for example in that the opening in the second object is not rotationally symmetrical, whereby a positive-fit with respect to rotational movements is created.

As an alternative to having a head portion of the described kind, a connector may be shaped to be inserted until a proximal surface of the connector is flush with a proximal surface of the first building layer, or until at least a portion of the connector's proximal surface is flush with a proximal surface of the first building layer.

In embodiments, the connector may have a proximal collar-like protrusion protruding towards radially outward and shaped to be pressed against the edge of the remaining first building layer so as to seal off the connector with respect to the first building layer.

Especially, a functional portion of the connector, such as a fastener receiving portion (that may, for example, include a threaded hole open to proximally), may be arranged so that after the anchoring process it is distally of the proximal surface of the first building layer, i.e., is “within” the first object.

In all embodiments, the method may include the additional step of maintaining a pressing force for some time after the step of stopping the energy transfer. This may be done at least until the flow portion has lost its capability of flowing, which, depending on the dimension of the connector and on heat conducting properties of the first object, may be the case within typically a few seconds.

Generally, the connector may be a classical connector for connecting a second object to a first object. To this end, the connector, as mentioned, for example may include a head portion that defines a distally facing shoulder so that a second object having an opening through which the connector reaches is clamped between the first object and the head portion. Alternatively, the connector may include a connecting structure, such as an inner or outer thread, a bayonet coupling structure, a structure allowing a click-in connection or any other suitable connecting structure. In these cases, the connecting structure may optionally be formed as part of a portion of the connector which portion is not of the thermoplastic material.

In addition or as an alternative to being such a classical connector, the connector may be an integral part of a second object that itself has a dedicated function—for example, the connector may be a connecting peg protruding from a surface of such second object. The connector may also connect a comparably small further object to the first object, for example a sensor or actuator or light source and/or other element, which further object may be integrated in the body of the connector.

Especially in a group of embodiments, the connector may include addition to the anchoring structure, a functional structure.

The flow portion of the thermoplastic material is the portion of the thermoplastic material that during the process and due to the effect of the mechanical energy is caused to be liquefied and to flow. The flow portion does not have to be one-piece but may include parts separate from each other, for example at the distal end of the connector and at a more proximal place.

For applying a counter force to the pressing force, the first object may be placed against a support.

In this text the expression “thermoplastic material being capable of being made flowable” or in short “liquefiable thermoplastic material” or “liquefiable material” or “thermoplastic” is used for describing a material including at least one thermoplastic component, which material becomes liquid (flowable) when heated, in particular when heated through friction, i.e., when arranged at one of a pair of surfaces being in contact with each other and moved relative to each other. In some situations, for example if the connector has to carry substantial loads, it may be advantageous if the material has an elasticity coefficient of more than 0.5 GPa. In other embodiments, the elasticity coefficient may be below this value.

Thermoplastic materials are well-known in the automotive and aviation industry. For the purpose of the method according to the present invention, especially thermoplastic materials known for applications in these industries may be used.

A thermoplastic material suitable for the method according to the invention is solid at room temperature (or at a temperature at which the method is carried out). It preferably includes a polymeric phase (especially C, P, S or Si chain based) that transforms from solid into liquid or flowable above a critical temperature range, for example by melting, and re-transforms into a solid material when again cooled below the critical temperature range, for example by crystallization, whereby the viscosity of the solid phase is several orders of magnitude (at least three orders of magnitude) higher than of the liquid phase. The thermoplastic material will generally include a polymeric component that is not cross-linked covalently or cross-linked in a manner that the cross-linking bonds open reversibly upon heating to or above a melting temperature range. The polymer material may further include a filler, e.g., fibres or particles of material that has no thermoplastic properties or has thermoplastic properties including a melting temperature range that is considerably higher than the melting temperature range of the basic polymer.

Specific embodiments of thermoplastic materials are: Polyetherketone (PEEK), polyesters, such as polybutylene terephthalate (PBT) or Polyethylenterephthalat (PET), Polyetherimide, a polyamide, for example Polyamide 12, Polyamide 11, Polyamide 6, or Polyamide 66, Polymethylmethacrylate (PMMA), Polyoxymethylene, or polycarbonateurethane, a polycarbonate or a polyester carbonate, or also an acrylonitrile butadiene styrene (ABS), an Acrylester-Styrol-Acrylnitril (ASA), Styrene-acrylonitrile, polyvinyl chloride, polyethylene, polypropylene, and polystyrene, or copolymers or mixtures of these.

In addition to the thermoplastic polymer, the thermoplastic material may also include a suitable filler, for example reinforcing fibers, such as glass and/or carbon fibers. The fibers may be short fibers. Long fibers or continuous fibers may be used especially for portions of the first and/or of the second object that are not liquefied during the process.

The fiber material (if any) may be any material known for fiber reinforcement, especially carbon, glass, Kevlar, ceramic, e.g., mullite, silicon carbide or silicon nitride, high-strength polyethylene (Dyneema), etc.

Other fillers, not having the shapes of fibers, are also possible, for example powder particles.

In this text, the terms “proximal” and “distal” are used to refer to directions and locations, namely “proximal” is the side of the bond from which an operator or machine operates, whereas distal is the opposite side. A broadening of the connector on the proximal side in this text is called “head portion”, whereas a broadening at the distal side would be a “foot portion”.

In this text, generally the term “underneath” a layer is meant to designate a space distally of this layer if the proximal side being defined to be the side of the layer from which it is accessed during the process. The term “underneath” thus is not meant to refer to the orientation in the earth gravity field during the manufacturing process.

The present invention in addition to the method also concerns a machine that is configured to carry out the method. Such machine includes a tool with a coupling structure, a source of rotational movement configured to cause the tool to rotate, and a relative force mechanism to apply the relative forces, for example by pushing the tool forward. The machine is configured and programmed to carry out the method as claimed and described in this text, including controlling the relative force in the manner described and claimed herein.

### BRIEF DESCRIPTION OF THE DRAWINGS

In the following, ways to carry out the invention and embodiments are described referring to drawings. The drawings are schematic in nature. In the drawings, same reference numerals refer to same or analogous elements. The drawings show:

FIGS. 1-3 sections through a first configuration during different method steps;

FIGS. 4-12 alternative connectors or details thereof;

FIG. 13 an other configuration;

FIG. 14 an even further connector;

FIGS. 15-17 further configurations;

FIG. 18 a process diagram;

FIG. 19 an even further configuration;

FIG. 20 a configuration with a first object being a structure of fibers;

FIGS. 21 and 22, during two different stages, a configuration with a first object being a foam material;

FIGS. 23 and 24 two embodiments of connectors; and

FIG. 25 a partial cross section through an even further connector.

### DESCRIPTION OF THE PREFERRED EMBODIMENTS

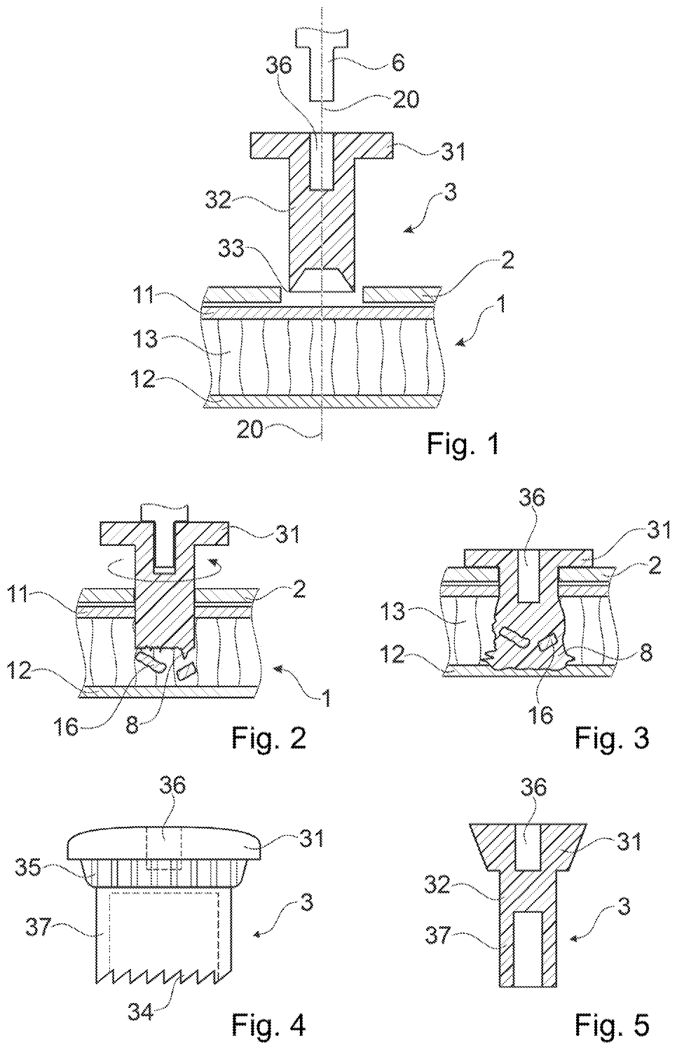

The configuration of FIG. 1 includes a first object 1 being a sandwich board with a first building layer 11, a second building layer 12, and an interlining 13 between the building layers. The first and second building layers may include a fiber composite, such as a continuous glass or continuous carbon fiber reinforced resin. The interlining may be any suitable lightweight material, for example a honeycomb structure of cardboard, of a plastic material or of a composite.

An often seen interlining structure is a honeycomb structure with walls forming the honeycomb structure extending approximately perpendicular to the building layer plane between the building layers. For example lightweight building elements of which the interlining layer includes honeycombs of paper, which is covered by a polymer based material such as by a mixture of polyurethane (PU) and reinforcing fibers.

The interlining may include barrier foils and/or web and/or adhesive layers at the interfaces to the building layers. Especially, an additional adhesive may bond the building layers 11, 12 to the interlining 13. In an example, a slightly foaming adhesive on polyurethane basis is used. Possible pores in the adhesive may contribute to the anchoring in the various embodiments of the invention. The face that in the depicted orientation is the upper face in this text is denoted as the proximally facing face. The connector 3 is bonded to the first object 1 from the proximal side.

The connector 3 includes thermoplastic material at least on a distal end thereof. It may, for example, consist of the thermoplastic material. The connector in the embodiment of FIG. 1 and other embodiments described hereinafter has a head portion and a distally protruding shaft portion 32. The shaft portion ends in a distal edge 33, for example formed by a circumferential ridge.

The connector 3 includes a proximally facing engagement opening 36 for a rotation tool 6 to engage. The engagement opening is a blind opening having a non-circular cross section—for example a rectangular or hexagonal cross section—so that the rotation tool 6 may transfer an angular moment to the connector to rotate the connector 3 about a rotation axis 20 that may extend parallel to the proximodistal direction. In general, any non-circular cross section of the engagement opening and corresponding outer cross section of the rotation tool or more in general any not rotationally symmetrical engagement structure is possible; also a force fit connection between the rotation tool and the connector may be used to rotate the connector.

For anchoring the connector in the first object, the connector is pressed against the first object and rotated. Prior to bringing the connector 3 in contact with the first object 1, optionally a pilot hole may be made in the first object (not shown in FIG. 1).

By the joint application of the pressing force and the rotation, the connector is driven into the first object 1. Due to the effect of the distal edge 33 formed by the connector, in an initial phase a circular portion of the first building layer 11 is detached from the main portion and/or is disintegrated by the impact of the rotation and the pressing force, whereby the connector may start penetrating into the first object 1.

Subsequently (and possibly to some extent also during penetration through the first building layer 11), the energy absorbed especially due to friction between the rotating connector and the first object causes a flow portion 8 of material of the connector to be made flowable (FIG. 2). The pressing force and possibly also to some extend the centrifugal forces cause the flow portion to be displaced. Depending on the material of the first object, also material of the first object may optionally be made flowable, and in some embodiments a common melt of material of the first object and the connector may be generated, which common melt after re-solidification results in a weld. In FIG. 2, fragments 16 of the detached portion of the first building layer are illustrated as merely displaced but not molten; in other embodiments this portion may be at last partially molten and intermixed with the flow portion.

FIG. 3 shows the connector anchored in the first object with the flow portion 8 re-solidified and interpenetrating structures of the first object, whereby an anchoring results, which anchoring is at least partly due to a positive-fit connection between the re-solidified flow portion and the structures of the first object.

In the embodiment of FIGS. 1-3, the connector is used to secure a second object 2 for example being a metal plate to the first object by the head portion 31 that in the final state (FIG. 3) clamps the second object 2 against the proximal surface of the first object. However, —this pertains to this embodiment and any other embodiment of the present invention—other approaches of securing a second object to the first object 1 may be used, including providing the connector with an engagement structure for a fastener (screw, pin, etc.) that fastens the second object, providing the connector with an engagement structure directly for the second object (such as a structure for a clip connection, a thread, etc.), integrating the second object into the connector, etc.

In accordance with an aspect of the invention, the connector has a (especially distally facing) contact surface that during the anchoring process comes into contact with the first object, which contact surface defines more than one contact point when the connector is brought into contact with an essentially flat surface of the first object. More in concrete, the contact surface in FIG. 1 includes the circumferential distally facing ridge ending in an edge 33. The edge in the embodiment of FIG. 1 is peripheral with respect to the shaft portion 32, whereby it contributes to detaching the mentioned circular portion, effectively punching out an opening in the first building layer 11 into which opening subsequently the shaft is advanced (FIG. 2).

FIG. 4 shows an alternative connector, where the distal end forms a tube portion 37 ending in a distal edge with a saw tooth structure 34. By this, the detaching of a circular portion of the first building layer is done in a sawing manner. The distal saw tooth structure—as well as other distal structures having a punching effect—may not only contribute to the breaking through the first building layer 11 but may also have an effect in further advancing the connector 3 into the less dense layer (interlining 13 in the illustrated examples) underneath.

The connector 3 shown in FIG. 4 has a further feature that is optional for any embodiments and that does not necessarily have to be combined with the sawtooth structure. Namely, the connector has a collar 35 of axially running ribs that protrude radially from the diameter of the tube portion and/or shaft portion (i.e., from an essentially cylindrical or possibly (in other embodiments) slightly conical outer surface). The collar 35 is immediately distally of the head portion 31, it comes into contact with a rim of the first building layer 11 around the opening caused by the introduction of the connector towards the end of the anchoring process. Thereby, additional friction is caused between the comparably harder first building layer and the connector, and thermoplastic material of the connector will be caused to flow also at this proximal position, whereby it will cause an additional connection with the first building layer and/or a sealing.

Instead of axially running ribs, other such proximal radially protruding features may be present distally of the head portion, for example at least one circumferential rib, a step feature, an array of protrusions, for example forming a chess-board-like pattern, etc.

FIG. 5 illustrates another embodiment of a connector with a distal tube portion 37 and proximally thereof a shaft portion. As further difference to the embodiment of FIG. 1 (that is independent of the more pronounced tube portion) is the shape of the head portion. Namely, the head portion 31 is conical, whereby it may, for example, be pressed into the opening of a second object 2 of the kind illustrated in FIGS. 1-3, so that it may sealingly engage the second object.

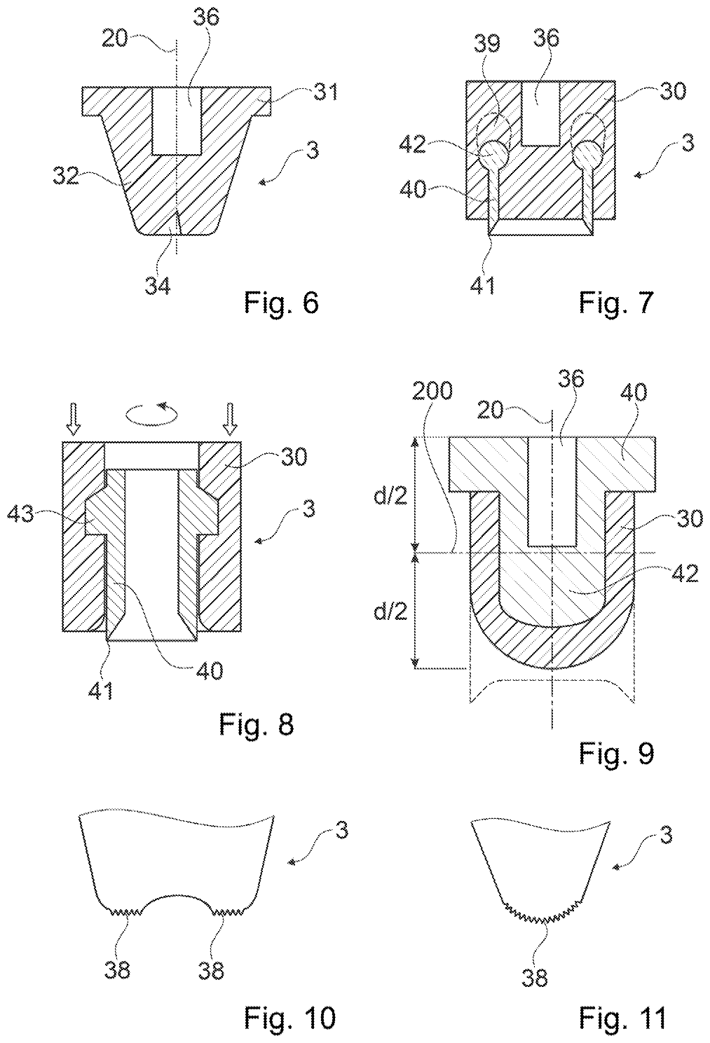

FIG. 6 illustrates a variant of a connector 3 that has a distal end that is generally flat with a cutting feature 34 formed at a position approximately centrally with respect to the axis 20. When the connector is brought into contact with the first building layer and set into rotational movement, the cutting feature will work into the material of the first building layer, which first building layer during the subsequent process will be slowly consumed away in a milling manner when the connector further penetrates into it. This may be assisted by a roughness (see hereinafter) or other structure along the periphery of the shaft portion 21.

In embodiments, such cutting feature may slightly protrude radially and/or distally for enhanced effectiveness. Also, a cutting feature may, in an alternative, formed by an element of a non-liquefiable material in accordance with condition example, for example, as cutting platelet of ceramics or of a metal, which may during the process retract in the manner described hereinafter referring to FIG. 8.

The embodiment of FIG. 7 is an example of a ‘hybrid’ connector, i.e., a connector that does not consist of the thermoplastic liquefiable material only but that includes a portion of a different material. It is in particular an example of a connector that includes a portion of not liquefiable material (i.e., metallic material in the shown embodiment) that forms a distal separating and/or material removing structure.

More in concrete, the connector 3 of FIG. 7 includes a thermoplastic part being an essentially cylindrical body 30 of the thermoplastic material and includes a metallic part being a metal sleeve 40 having a distal cutting edge 41 protruding distally from the body 30 and a proximal bulge 42. When the connector is pressed against the first object 1 while being rotated, the bulge 42 assists in mechanically stabilizing the metal sleeve 40 with respect to the body 30 so that it can exert a pressing force on the first object until a circular portion of the first building layer is cut out, and pressed into the first object 1. During this, some heat will be absorbed by the metal sleeve 40. As soon as the distal end of the body 30 comes into contact with the first object, additional heat will be absorbed at the interface between the body 30 and the first object, whereby the anchoring process described referring to FIGS. 1-3 may take place. Due to the heat generated, thermoplastic material proximally of the sleeve (reference number 39 in FIG. 7) may become softened, whereby the sleeve may be pressed into the body 30, so that after some time, especially when the distal end of the connector 3 reaches the second building layer 12 (if any), then the sleeve is fully retracted into the body 30 and the edge 41 does not have any cutting effect any more.

The principle shown referring to FIG. 7 does not depend on the shape of the connector body 30 and pertains equally to other shapes, including shapes with a conical body and/or with a head portion.

FIG. 8 shows an other embodiment that implements the principle of FIG. 7. In this embodiment, the thermoplastic part (body) 30 forms an outer sleeve, and the metallic part 40 forms an inner sleeve ending in a distal edge 41. A plurality of outward protrusions 43 of the inner sleeve 40 or a single, for example circumferential outward protrusion engage(s) into corresponding indentations of the thermoplastic body 30. The outward protrusion(s) 43 may have, as illustrated in FIG. 8, a sloped, ramp-like shape towards proximally to reduce resistance against the retracting movement that withdraws the cutting edge after the metallic part has become sufficiently hot, as described referring to FIG. 7.

The arrangement of outer and inner sleeves could be reversed in FIG. 8; then optionally the thermoplastic body instead of an inner sleeve could be an inner bolt. Embodiments with the not liquefiable part being an outer sleeve may especially be advantageous for making thermoplastic material of the body flowable a contact between the first building layer and the thermoplastic material is not necessary and for example not desired—heat absorption and making flowable then primarily takes place at the interface between the interlining layer and/or the second building layer (if any) on the one hand and the body of the connector on the other hand.

FIG. 9 shows yet another embodiment of a hybrid connector. The metallic part 40 forms the proximal head as well as the engagement opening 36 and has a metallic part shaft portion 42 that however does not reach to the distal end. For a strong stability, especially against shear forces, however, the metallic part reaches rather far towards distally, for example, the metallic part may extend at least through a middle plane 200 (perpendicular to the axis 20) of the connector.

The connector of FIG. 9 is shown to have a rounded distal end, however, as illustrated by the dotted line, it could also have other shapes, including shapes with a distal radially outer ridge, similar to FIG. 1.

In a variant of the embodiment of FIG. 9, the metallic part could extend through the entire length of the connector and distally end in a tip or blade thereby making the breaking through/pierce/cut through a high-strength first building layer possible. In this variant, the bore generated in the first building layer by the metallic part is smaller than a diameter of the connector and primarily serves for weakening the first building layer without entirely removing it—thereby the flowing of flowable thermoplastic material underneath the first building layer and integrating in an anchoring structure may be further improved.

FIGS. 10 and 11 show distal ends of connectors of two different shapes. The distal end surfaces have a roughened portion 38, whereby the connectors impinge on the first building layer in an abrasive manner.

More in particular, the roughness (Ra, arithmetic average roughness) of such roughened portion is at least 10 μm or at least 20 μm or even at least 50 μm.

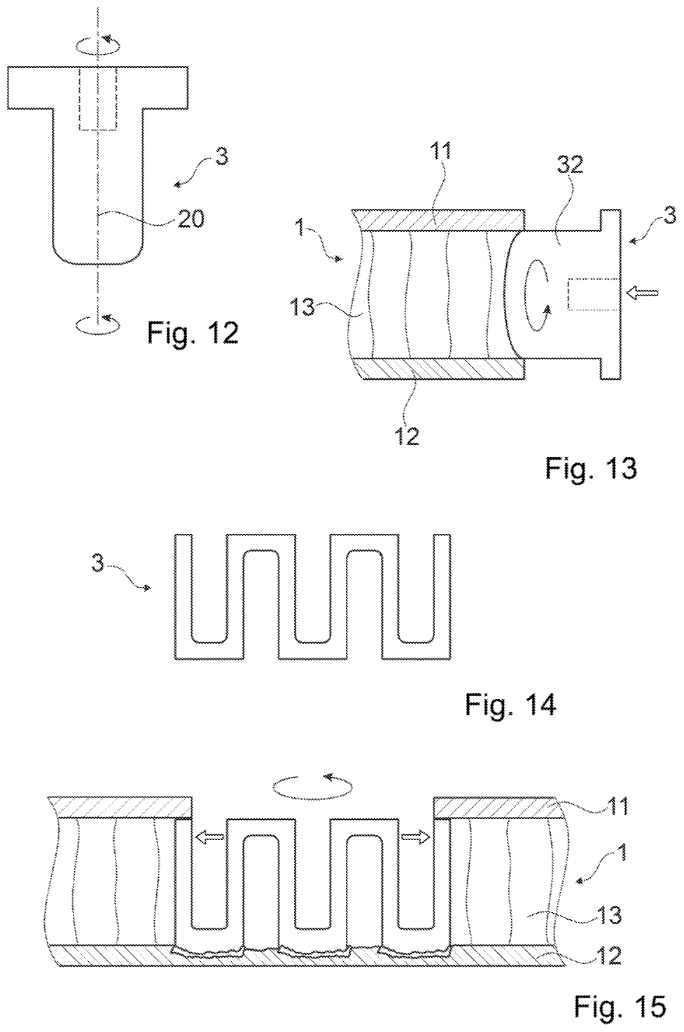

FIG. 12 illustrates another aspect of the invention. Namely, the connector during the process may, according to this aspect, be not only subject to rotational movement but during the rotation the rotation axis itself moves, especially rotates around a parallel orbit axis while maintaining its orientation (orbital movement). Thereby, the anchoring effect may be enhanced.

FIG. 13 shows an even further aspect. The connector is anchored in the first object 1 being a lightweight building element from a face side instead of through a first building layer. The diameter of the shaft portion 32 (or a tube portion or similar) may be chosen such that it is slightly larger than a thickness of the interlining 13 but smaller than a thickness of the entire lightweight building element, whereby a good anchoring with respect to all, the first and second building layers 11, 12 as well as the interlining may result.

FIG. 14 illustrates an even further aspect. According to this aspect, the connector 3 has a variable radial width. In the shown embodiment, the connector is formed by a body of axial bars connected by circumferentially running bridges, alternatingly arranged proximally and distally, respectively. Thereby, the radius of the whole connector can be varied by elastic (and/or plastic) deformation of the bars/bridges and their connections.

FIG. 14 illustrates the connector 3 in a compressed configuration in which it may be inserted in a pre-made bore in the first object 1, which pre-made bore at least goes through the first building layer 11. Then, as illustrated in FIG. 15, as soon as the force that elastically compresses the connector is released and/or (also if no such radial compressing force was present initially) due to the centrifugal forces, the radial extension of the connector becomes bigger, whereby an additional anchoring effect is achieved, especially if the connector extends to distally of the first building layer 11, as shown in 15, and is stabilized by a blind rivet effect in addition to the anchoring by the thermoplastic material interpenetrating structures of the first object and/or a weld.

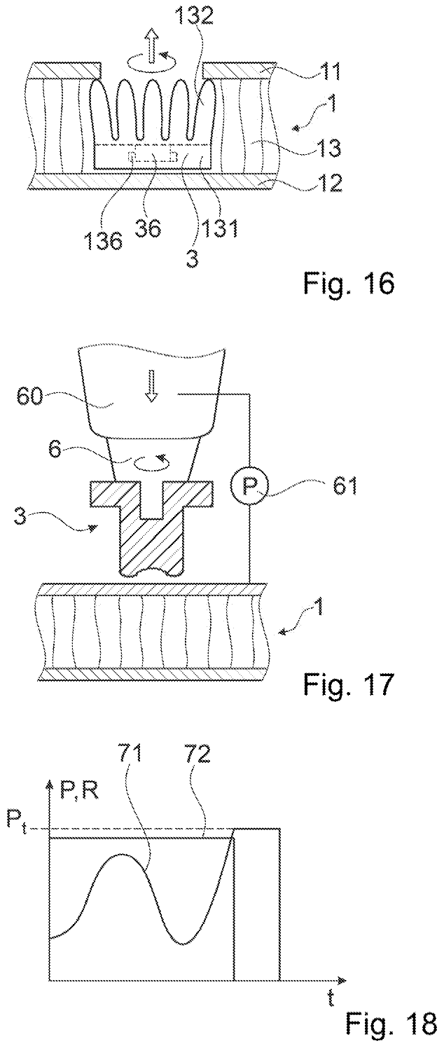

FIG. 16 shows an embodiment with a connector 3 that has a distal body portion 131 and a plurality of elastically deformable tongues 132 that deformed radially inwardly for introduction through the pre-made bore and resiz radially outwardly after they are distally of the first building layer, as illustrated in FIG. 16. For anchoring, the rotation and a pulling force are coupled into the connector, whereby the thermoplastic material of the connector is liquefied in contact with the first building layer 11, along its distally facing surface. For coupling the pulling force into the connector, the body portion 131 may, in addition to the engagement opening 136 also include a structure that allows coupling a pulling force into it, for example a snap-in structure 136.

FIG. 17 illustrates an example of process control, for embodiments that include exerting a pressing force (thus embodiments other than the embodiment of FIG. 16). An apparatus 60 is configured to rotate the rotation tool 6 and to exert the pressing force. The apparatus includes an electronic control including a pressing force measuring device 61.

FIG. 18 shows the pressing force 71 and the rotation 72 as a function of time for a pressing force controlled process. The pressing force 71 may be configured to rise during an initial phase until the first building layer is broken through and/or removed by the rotating connector 3. Then, the pressing force goes back due to the lower resistance in the interlining layer. As soon as the distal end of the connector reaches the second building layer or denser structures nearby it, with the abrasive and/or cutting structures at the distal end consumed away or retracted in the meantime (as described for the embodiments hereinbefore), the pressing force required for moving the connector forward goes up again. As soon as a threshold value pₜ is reached, the rotation is switched off, whereas the pressing force is maintained for some time thereafter until the thermoplastic material has re-solidfied;

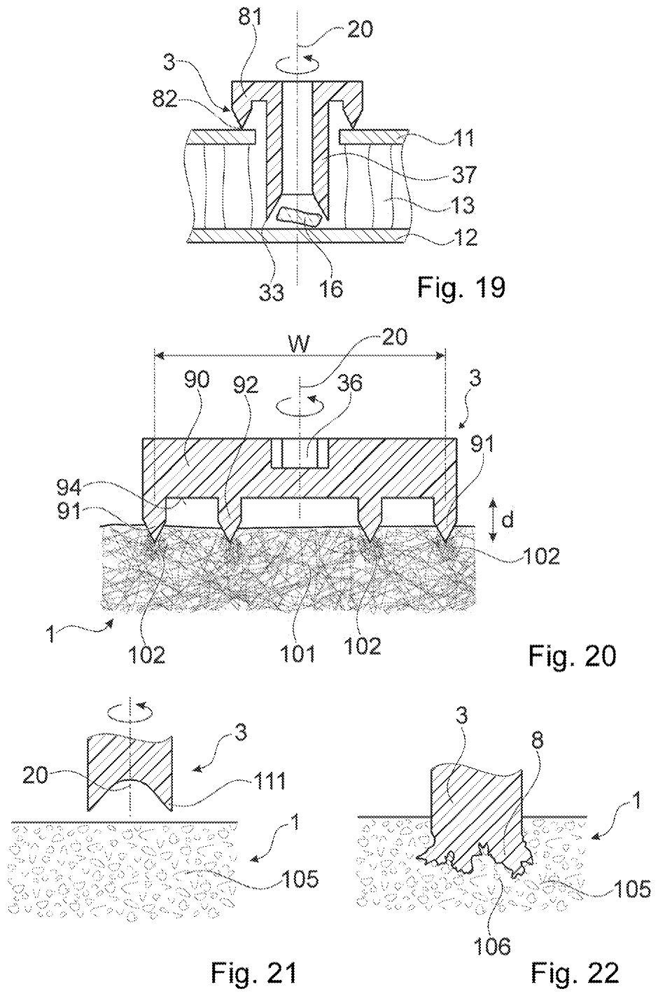

FIG. 19 illustrates, in combination, two further principles that apply both to first objects being lightweight building elements, for example sandwich boards. These two principles may be applied independently, though, i.e., it is possible to carry out the method with the first principle but without the second principle, or also to carry out the method with the second principle but without the first principle, in addition the combination being an option.

The first principle is that the connector 3 is used to punch out a portion (fragment 16) of the first building layer 11. To this end, the connector has a circumferential distal edge 33, in the depicted embodiment formed by a tube portion 37. Such circumferential distal edge 33 capable of punching out a portion of the first building layer 11 is also a property of the above-described embodiments of FIGS. 1 and 5.

The punching step, by the distal edge 33 may be carried out prior to the onset of the rotational movement, during the onset, or thereafter.

The second principle is that the connector 3 has a proximal connecting portion 81 with a distally facing connecting protrusion 82 that is arranged to penetrate into material of the first object from a proximal end face thereof. Especially, the connecting portion may form a flange, for example a proximal flange, around an inner portion (which inner portion in FIG. 19 is the tube portion but which inner portion could have an other shape also), with a distally facing, for example circumferential connecting protrusion of the thermoplastic material. The connecting protrusion may form a circumferential ridge distally ending in an edge. The connecting protrusion may extend around the axis 20 uninterruptedly or for example also interruptedly.

The anchoring process may then include the step of causing a material portion of the inner portion to become flowable and to flow relative to the second building layer 12 and, for example, penetrate into structures of the second building layer and/or structures immediately adjacent the second building layer—and, for example, at the same time causing an other material portion, of the connecting portion 81 to become flowable and to be pressed into structures of the first building layer 11 from proximally. More in general, the method may include anchoring an inner portion of the connector distally of a first building layer 11 and anchoring a radially-outer connecting portion by pressing it against a proximally-facing surface of the first building layer while being rotated.

FIG. 20 illustrates the principle of anchoring a connector 3 in a first object 1 being a structure of fibers 101, for example a nonwoven fabric. Especially, the fibers may have the property of not becoming flowable at the temperatures at which the thermoplastic material flows, i.e., a non-liquefiable material according to the definition used in the present text.

The connector 3 used to be anchored relative to the structure of fibers differs from the previous embodiments in that it is adapted to the material. More in concrete, if anchored from a proximally facing surface of the structure of fibers, the connector will be capable of penetrating less deeply compared to sandwich board for example. This is because if an object (connector) is pressed against the fibers, this will result in an enhanced mechanical resistance due to the density that locally increases by compression of the structure. Therefore, a width w of the structures that penetrate into the structure of fibers will often be substantially larger than a depth d thereof.

In embodiments, the connector includes at least one circumferential ridge 91, 92 extending around the rotation axis 20, which ridge 91, 92 forms an anchoring portion of the connector.

The following options exist:
Prior to the onset of the rotations, the connector may be pressed by an axial movement into the material of the first object 1. Thereby, locally, at the location of the anchoring portion(s), the fiber structure is compressed to yield a compressed portion 102 that is illustrated schematically in FIG. 20. It has been found that this may assist the anchoring process in that the friction between the material of the first object 1 and the thermoplastic material of the anchoring portion(s) is enhanced yielding an enhanced energy absorption, while also the resistance against the fibers merely being pulled along in the rotational movement is also enhanced.
In addition or as an alternative, the depth d and the process parameters are chosen in a manner that after the process, the anchored connector 3 still has the distinct anchoring portion(s) 91, 92. I.e., the material of the anchoring portion(s) is not completely smeared out by the process but an in-depth anchoring of the connector by the anchoring portion results.
In addition or as yet another alternative, the process is carried out until a distally facing surface portion 94 of a main body 90 abuts against a proximally facing surface of the first object 1.

FIG. 21 illustrates an even further embodiment in which the connector is anchored, by the rotation, in a first object being an object of a compressible foam, for example as Expanded Polysterene (EPS) or Expanded Polypropylene (EPP). In the illustrated embodiment, the first object 1 is a foam with closed pores 105; the method would also be applicable for open porous compressible foams.

Especially, the foam may be of a material that is not liquefiable according to the definition of the present, i.e., if the foam is of a thermoplastic material, its liquefaction temperature is substantially higher than a liquefaction temperature of the connector thermoplastic material.

Alternatively, the foam material may be liquefiable and for example—but not necessarily—capable of being welded to the thermoplastic material of the connector. Thereby, the effect of the positive fit that results in anchoring may be supplemented by a material bond (i.e., weld).

The connector 3 may optionally have a distal structure according to condition A above. FIG. 21 shows the distal end of the connector forming a shallow circumferential protrusion 111.

Also for anchoring in a foam material, the connector may optionally be pressed into material of the first object (foam material) by an axial movement prior to the onset of the rotations. The effect of such compression is, similar to the above-described example, increased friction, together with an enhanced mechanical stability.

FIG. 22 shows the configuration after the anchoring process. The flow portion 8 interpenetrates structures of the first object, for example by penetrating into pores that were opened in the process and/or already open pores and/or other structures. An intertwined configuration of the flow portion and these structures results.

FIG. 22 also illustrates a compressed zone 106 distally of the connector 3. This compressed zone may result prior to the onset of the rotational movement by the connector being pressed into the material of the first object, and/or may result by the joint action of the pressing force and the rotational movement. The compressed zone 106 is mechanically stabilized by the re-solidified flow portion and/or by the connector being anchored as a whole.

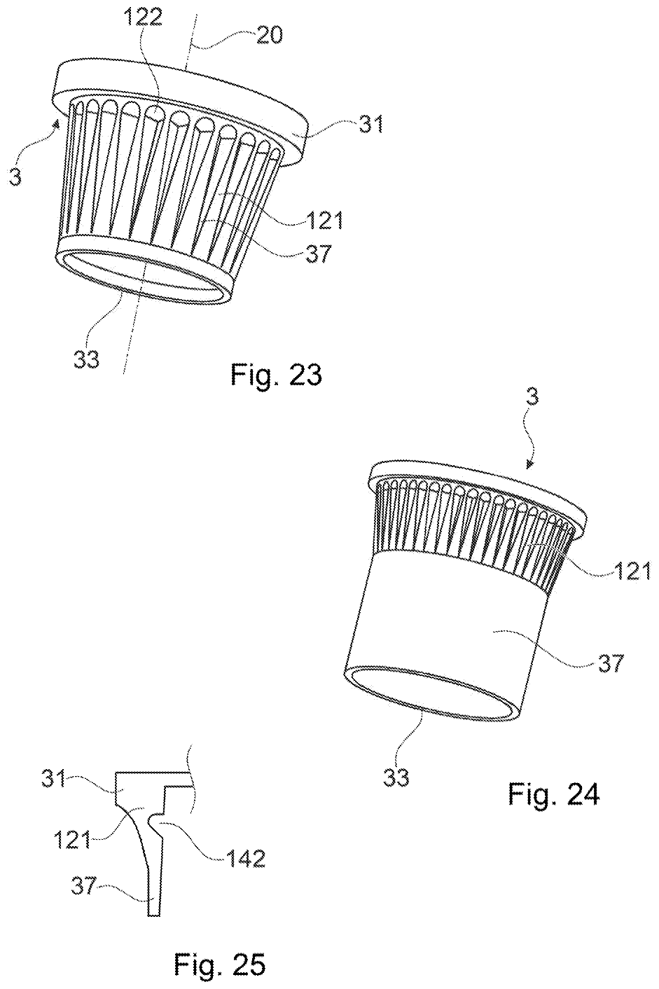

FIG. 23 shows a further embodiment of a connector 3. The connector is based on the principle described referring to FIGS. 1, 5 and 19 by including a distal edge 33 capable of punching a hard first building layer or other rigid structure of the first object.

Such structures with a distal edge and a tube portion 37 proximally thereof are also suitable for being anchored relatively deeply in comparably dense material without being subject to too high a compression.

A further feature of the embodiment of FIG. 23 is that it comprises, similarly for example to the embodiment of FIG. 6, a region with a cross section (perpendicular to the axis 20) that continually increases towards proximally, whereby when the connector is pressed into the first object while rotated there is a continuous pressing force and friction along the periphery, which feature enhances the overall liquefaction efficiency.

In contrast to the embodiment of FIG. 6, however, the region of continually increasing cross section has a structure of ribs 121 intermittent with grooves 122 running axially along each other. The ribs define a homogeneous tapering enveloping rotation surface (surface of revolution) rotationally symmetrical around the axis 20. However, since the grooves are between them, the energy input required for making them flowable is reduced compared to a massive cross section with homogeneous surface as in FIG. 6. Therefore, the process is quicker compared to a connectors with a massive cross section.

The embodiment of FIG. 24 is based on the same principle. However, the tube portion 37 has an extended length, (axial dimension), whereby the embodiment of FIG. 24 is especially suited for being anchored in comparably thick objects of limited density, such as sandwich boards with a relatively thick interlining layer.

FIG. 25 illustrates a further optional principle that may be present in addition or as an alternative to the tapering region with or without ribs. Namely, the connector 3 may include an inner or outer weakening feature, such as an inner groove 142 assisting a collapse and an effect of lateral expansion of liquefied thermoplastic material, for example immediately distally of the first building layer. Especially, the centrifugal force will contribute to such lateral expansion, and a locally weakened zone next to the inner groove 142 or other local weakening feature may serve as a plastic hinge in this.

1. A method of anchoring a connector in a first object, wherein the connector comprises thermoplastic material in a solid state, the method comprising the steps of:
bringing the connector into physical contact with the first object,
rotating the connector relative to the first object around a proximodistal rotation axis and exerting a relative force by the connector onto the first object, until a flow portion of the thermoplastic material of the connector becomes flowable and flows relative to the first object, and
stopping rotation of the connector, whereby the flow portion anchors the connector relative to the first object,
wherein at least one of the following conditions is fulfilled:
A. the connector is shaped so that a distal-most end thereof is different from a contact point on the proximodistal rotation axis;
B. a portion of the connector has a macroscopic surface roughness;
C. the connector comprises a portion of a second material different from the thermoplastic material, wherein said second material is solid and does not become flowable, and wherein said portion either extends to the distal end or extends through a middle plane perpendicular to the axis, or both;
D. during the step of rotating, the connector is subject to an orbital movement;
E. the connector has an inner portion and a proximal connecting portion with a distally facing connecting protrusion, wherein during the step of rotating, the connecting protrusion is pressed against a proximally facing end face of the first object and a surface part of the inner portion is pressed against a first object structure distally of the proximally facing end face;
F. the first object comprises a structure of fibers or a foam material, and the flow portion is caused to flow into the structure of fibers or into pores of the foam material, respectively.

2. The method according to claim 1, wherein the relative force is a pressing force.

3. The method according to claim 1, wherein at least a region of the first object, in which region the flow portion flows, comprises non-liquefiable material.

4. The method according to claim 1, wherein at least condition A. is fulfilled, and wherein the distal-most end forms one of:
a circular contact line;
a saw-tooth structure;
an edge running different from circumferentially,
an abrasive area;
a hollow, sleeve-like distal end;
a cutting and/or punching structure of the second material.

5. The method according to claim 1, wherein at least condition A. is met, comprising the step of punching out a portion of an outermost layer of the first object prior to rotating the connector and/or at an initial rotation stage while the connector is rotated.

6. The method according to claim 1, wherein at least condition B. is met, wherein the arithmetic average surface roughness of the distal end face portion is at least 20 □m.

7. The method according to claim 1, wherein at least condition B is met, wherein at least a distal end face portion of the connector has a macroscopic surface roughness.

8. The method according to claim 1, wherein at least condition C is met, wherein the non-liquefiable material forms a distal cutting/punching and/or material removal feature.

9. The method according to claim 8, and further comprising a step of causing the body of the non-liquefiable material to retract relative to the thermoplastic material during the step of exerting the relative force.

10. The method according to claim 1, wherein the first object is a lightweight building element having a first building layer and an interlining layer, wherein the first building layer is thinner and more dense than the interlining layer.

11. The method according to claim 10, wherein the first object further comprises a second building layer wherein the second building layer is thinner and more dense than the interlining layer.

12. The method according to claim 10, further comprising a step of: by the action of the rotation and/or the relative force, displacing a portion of the first building layer with respect to the interlining layer.

13. The method according to claim 12, wherein the step of applying the relative force to displace the portion of the first building layer comprises displacing the portion towards a distal direction, thereby causing material of the interlining distally of the portion to be compressed.

14. The method according to claim 12, further comprising causing the portion to be punched out by the effect of the first pressing force.

15. The method according to claim 10, and further comprising causing the first outer building layer to be pierced as a result of the application of the relative force at the location where the connector is in physical contact with the first object or in a vicinity thereof.

16. The method according to claim 1, wherein at least condition E. is met, and wherein the connecting portion extends radially outwardly from the inner portion.

17. The method according to claim 16, wherein the connecting portion is a flange extending radially outwardly from the inner portion, and wherein the anchoring portion is a circumferential ridge extending distally from the flange.

18. The method according to claim 1, wherein at least condition F. is met, wherein the material of the first object is a non-woven fiber material.

19. The method according to claim 1, wherein at least condition F. is met, wherein the connector is pressed into the first object prior to an onset of the rotation.

20. The method according to claim 1, wherein the connector as a region with a cross section that continually increases towards proximally, and wherein during the step of rotating, this region is pressed into the first object.

21. The method according to claim 20, wherein said region has a structure of ribs and grooves.

22. The method according to claim 1, wherein the connector has a weakening feature, and wherein the step of rotating is carried out until the connector collapses at the location of the weakening feature for enhancing a flow of the flow portion towards radially outwardly.

23. A connector, usable in a method according to claim 1, the connector having an axis and comprising thermoplastic material in a solid state, the connector comprising a proximal engagement structure that is not rotationally symmetrical and is equipped for cooperating with a rotating tool for setting the connector into rotation around the axis, wherein at least one of the following conditions is fulfilled:
A. the connector is shaped so that a distal-most end thereof is different from a contact point on the proximodistal rotation axis;
B. the connector has a macroscopic surface roughness;
C. the connector comprises a portion of a second material different from the thermoplastic material, wherein said second material is solid and does not become flowable (during the process), and wherein said portion either extends to the distal end or extends through a middle plane perpendicular to the axis, or both;
E. the connector has an inner portion and a proximal connecting portion with a distally facing connecting protrusion.
